(19) United States
(12) Patent Application Publication
(10) Pub. No.: US 2026/0328974 A1
(43) Pub. Date: Oct. 22, 2026

(54) DIFFRACTION DEVICE AND DIFFRACTION METHOD

(71) Applicants: HAMAMATSU PHOTONICS K.K., Hamamatsu-shi (JP); The University of Electro-Communications, Tokyo (JP)

(72) Inventors: Yurina MICHINE, Tokyo (JP); Hitoki YONEDA, Tokyo (JP); Yoshinori TAMAOKI, Shizuoka (JP); Takashi SEKINE, Shizuoka (JP); Takaaki MORITA, Shizuoka (JP)

(73) Assignees: HAMAMATSU PHOTONICS K.K., Hamamatsu-shi (JP); The University of Electro-Communications, Tokyo (JP)

(21) Appl. No.: 19/648,625

(22) Filed: Apr. 15, 2026

(30) Foreign Application Priority Data
Apr. 17, 2025 (JP) 2025-068330

(51) Int. Cl. G02B 5/18

(52) U.S. Cl. CPC G02B 5/18

(57) ABSTRACT

A diffraction device includes a supply unit configured to supply a gas to a predetermined region, a first irradiation unit configured to irradiate the predetermined region with first laser light and second laser light, and a second irradiation unit configured to irradiate the predetermined region with third laser light, wherein the gas includes molecules that resonantly absorb the first laser light, the second laser light, and the third laser light, wherein the first irradiation unit forms interference fringes in the predetermined region by irradiating the predetermined region with the first laser light and the second laser light so as to cross each other in the predetermined region, thereby forming a density modulation wave in the predetermined region caused by the interference fringes, and wherein the second irradiation unit increases the spatial frequency of the density modulation wave.

### TECHNICAL FIELD

The present disclosure relates to a diffraction device and a diffraction method.

### BACKGROUND

Japanese Unexamined Patent Publication No. 2021-105693 describes a diffractive condensing optical element device. This diffractive condensing optical element device includes a gas generating means that supplies a gas containing molecules that resonantly absorb light to form a certain region, and a light excitation means that irradiates excitation laser light having a wavelength in the absorption band of the molecules so as to cross within the region to optically excite the gas, and that generates interference fringes having curvature within the region by having at least one of a condensing optical system and a diverging optical system in at least one of the optical paths of the two crossing excitation laser lights.

### SUMMARY

In the diffractive condensing optical element device described in Japanese Unexamined Patent Publication No. 2021-105693, controlled laser light can be diffracted by causing the controlled laser light to enter interference fringes (i.e., a density modulation wave of the gas) formed in the gas. The spatial frequency of this density modulation wave affects the diffraction angle of the controlled laser light. When it is necessary to increase the diffraction angle of the controlled laser, it is necessary to form a density modulation wave with a high spatial frequency. One method for increasing the spatial frequency of the density modulation wave is to increase the crossing angle of the two excitation laser lights, but there is a limit in terms of the density modulation wave generation process. Therefore, in order to further increase the spatial frequency of the density modulation wave, it is conceivable to shorten the pulse width of the excitation laser light, but in this case, this causes the light source device of the excitation laser light to become more complex.

Therefore, the present disclosure aims to provide a diffraction device and a diffraction method capable of easily increasing the spatial frequency of a density modulation wave of a gas.

A diffraction device according to the present disclosure is [1] “a diffraction device including: a supply unit configured to supply a gas to a predetermined region; a first irradiation unit configured to irradiate the predetermined region with first laser light and second laser light; and a second irradiation unit configured to irradiate the predetermined region with third laser light, wherein the gas includes molecules that resonantly absorb the first laser light, the second laser light, and the third laser light, wherein the first irradiation unit forms interference fringes in the predetermined region by irradiating the predetermined region with the first laser light and the second laser light so as to cross each other in the predetermined region, thereby forming a density modulation wave in the predetermined region caused by the interference fringes, and wherein the second irradiation unit increases the spatial frequency of the density modulation wave by irradiating the predetermined region with the third laser light in a peak region of diffraction efficiency of light based on the density modulation wave, the peak region being within a time range after the first laser light and the second laser light are irradiated onto the predetermined region.”

A diffraction method according to the present disclosure is [9] “a diffraction method including: a supply step of supplying a gas to a predetermined region; a first irradiation step of irradiating the predetermined region with first laser light and second laser light; and a second irradiation step of irradiating the predetermined region with third laser light, wherein the gas includes molecules that resonantly absorb the first laser light, the second laser light, and the third laser light, wherein in the first irradiation step, interference fringes are formed in the predetermined region by irradiating the predetermined region with the first laser light and the second laser light so as to cross each other in the predetermined region, thereby forming a density modulation wave in the gas in the predetermined region caused by the interference fringes, and wherein in the second irradiation step, the spatial frequency of the density modulation wave is increased by irradiating the predetermined region with the third laser light in a peak region of diffraction efficiency of light based on the density modulation wave, the peak region being within a time range after the first laser light and the second laser light are irradiated onto the predetermined region.”

In this diffraction device and diffraction method, the first laser light and the second laser light are irradiated onto the predetermined region to which the gas has been supplied so as to cross each other, thereby forming interference fringes in the predetermined region. The gas includes molecules that resonantly absorb the first laser light and the second laser light (and the third laser light). As a result, a density modulation wave (a state in which portions of high density and portions of low density of the gas are alternately formed in a stripe pattern) caused by the interference fringes is formed in the gas in the predetermined region. This makes it possible to diffract the controlled laser light by, for example, causing the controlled laser light to enter the predetermined region in which the density modulation wave of the gas has been formed (i.e., a state in which the controlled laser light can be diffracted is achieved). Then, in this diffraction device and diffraction method, the third laser light is further irradiated onto the predetermined region in a peak region of diffraction efficiency of light based on the density modulation wave, the peak region being within a time range after the first laser light and the second laser light are irradiated onto the predetermined region. According to the knowledge of the present inventors, this increases the spatial frequency of the density modulation wave of the gas. In this manner, according to this diffraction device and diffraction method, it is possible to easily increase the spatial frequency of the density modulation wave of the gas (compared to before the irradiation of the third laser light) without reducing the pulse widths of the first laser light and the second laser light.

The diffraction device according to the present disclosure may be [2] “the diffraction device according to [1] above, wherein the peak region is a time range in which the diffraction efficiency of light based on the density modulation wave is 80% or more relative to the peak.” In this case, the spatial frequency of the density modulation wave of the gas can be increased more reliably.

The diffraction device according to the present disclosure may be [3] “the diffraction device according to [1] or [2] above, wherein the pulse widths of the first laser light and the second laser light are 1 ns or more.” In this case, the spatial frequency of the density modulation wave of the gas can be increased without using a laser with a pulse width narrower than a nanosecond, which tends to make the configuration more complex.

The diffraction device according to the present disclosure may be [4] “the diffraction device according to any one of [1] to [3] above, wherein the second irradiation unit further irradiates the predetermined region with the third laser light in a peak region of diffraction efficiency of light based on the density modulation wave whose spatial frequency has been increased by the irradiation of the third laser light, thereby further increasing the spatial frequency of the density modulation wave.” In this case, the spatial frequency of the density modulation wave of the gas can be further increased.

The diffraction device according to the present disclosure may be [5] “the diffraction device according to any one of [1] to [4] above, wherein the gas includes ozone, and the first laser light, the second laser light, and the third laser light have center wavelengths at the absorption wavelength of ozone.” In this manner, by the gas including ozone and the first to third laser lights having center wavelengths at the absorption wavelength of ozone, it is possible to suitably form the density modulation wave in the gas in the predetermined region and to suitably increase the spatial frequency of the density modulation wave.

The diffraction device according to the present disclosure may be [6] “the diffraction device according to any one of [1] to [5] above, wherein the fluence of the third laser light is equal to or greater than the fluence of the first laser light and the second laser light.” In this case, it becomes possible to more reliably increase the spatial frequency of the density modulation wave of the gas by the irradiation of the third laser light.

The diffraction device according to the present disclosure may be [7] “the diffraction device according to any one of [1] to [6] above, wherein the irradiation region of the third laser light in the predetermined region includes the irradiation region of the first laser light and the second laser light in the predetermined region.” In this case, it becomes possible to increase the spatial frequency of the density modulation wave of the gas over the entire irradiation region of the first laser light and the second laser light by the irradiation of the third laser light.

The diffraction device according to the present disclosure may be [8] “the diffraction device according to any one of [1] to [7] above, wherein the second irradiation unit further irradiates the predetermined region with the third laser light in a time range in which the diffraction efficiency of light based on the density modulation wave whose spatial frequency has been increased by the irradiation of the third laser light is 20% or less relative to the peak, thereby reducing the amplitude of the density modulation wave.” In this case, after the third laser light is irradiated, the amplitude of the density modulation wave of the gas is reduced, and as a result, the controlled laser light incident on the predetermined region becomes less likely to be diffracted (i.e., a state in which the controlled laser light is less likely to be diffracted is achieved). That is, in this case, it becomes possible to switch at high speed between a state in which the controlled laser light can be diffracted and a state in which the controlled laser light is less likely to be diffracted (i.e., the diffraction state) in accordance with the irradiation of the third laser light.

According to the present disclosure, it is possible to provide a diffraction device and a diffraction method capable of easily increasing the spatial frequency of a density modulation wave of a gas.

### BRIEF DESCRIPTION OF THE DRAWINGS

FIG. 1 is a schematic diagram illustrating the configuration of the diffraction device according to the present embodiment.

FIGS. 2A, 2B, 2C, 2D, and 2E are graphs illustrating the time evolution of the spatial temperature distribution and density distribution of the gas.

FIG. 3 is a graph illustrating the time change of the diffraction efficiency of light based on the density modulation wave.

FIG. 4 is a graph illustrating the relationship between the rise time of the diffraction efficiency (vertical axis) and the interval of the density modulation wave (horizontal axis).

FIG. 5 is a graph illustrating the time change of the interval of the density modulation wave (number of grooves/mm).

FIGS. 6A and 6B are graphs illustrating the time evolution of the spatial temperature distribution and density distribution of the gas.

FIG. 7 is a diagram for explaining the control of the diffraction state.

FIG. 8 is a diagram for explaining the control of the diffraction state.

FIG. 9 is a diagram for explaining the control of the diffraction state.

FIGS. 10A and 10B are graphs illustrating the time change of the refractive index modulation amount.

FIG. 11 is a graph illustrating the time change of the diffraction efficiency.

FIGS. 12A and 12B are graphs illustrating the time evolution of the spatial temperature distribution and density distribution of the gas according to a modified example.

### DETAILED DESCRIPTION

Hereinafter, a diffraction device and a diffraction method according to an embodiment will be described with reference to the drawings. In the description of the drawings, the same or corresponding elements are denoted by the same reference numerals, and redundant descriptions may be omitted.

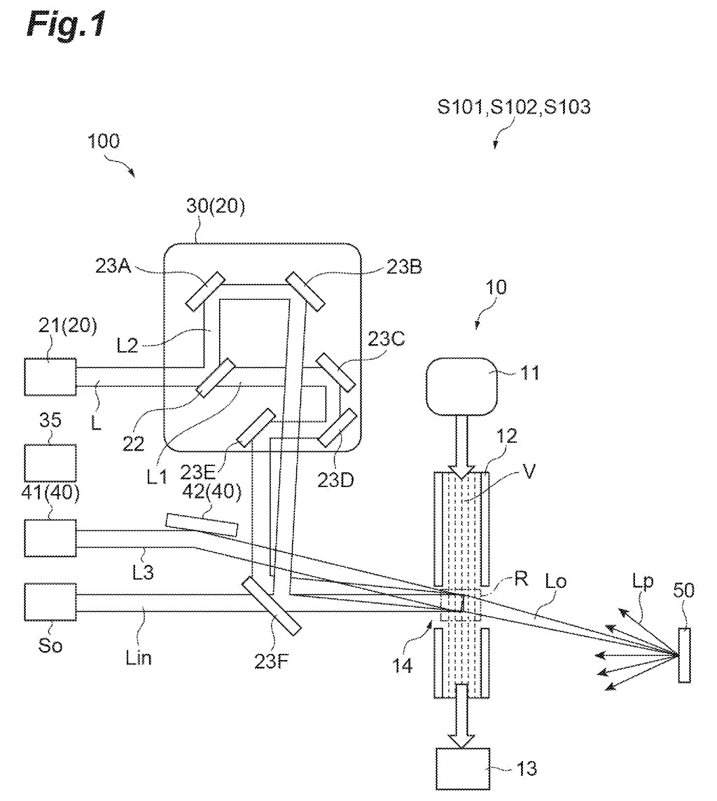

FIG. 1 is a schematic diagram illustrating the configuration of the diffraction device according to the present embodiment. A diffraction device 100 illustrated in FIG. 1 is for diffracting controlled laser light Lin. The diffraction device 100 includes a supply unit 10 that supplies a gas V to a predetermined region R, a first irradiation unit 20 for irradiating the predetermined region R with first laser light L1 and second laser light L2, and a second irradiation unit 40 for irradiating the predetermined region R with third laser light L3.

The supply unit 10 includes a gas supply unit 11, a flow path element 12, and a gas suction unit 13. The gas supply unit 11 is, for example, a pump, and supplies a gas V containing molecules that resonantly absorb the first laser light L1, the second laser light L2, and the third laser light L3. The gas V is, for example, a gas containing ozone. The concentration of ozone in the gas V may be, for example, a value sufficient for ultraviolet laser light (50 mJ/cm²) to be absorbed by a gas layer having a thickness of 3 mm to 10 mm (for example, approximately 1% to 3%).

When the gas supply unit 11 supplies the gas V containing ozone, one example of a method for generating the gas V containing ozone may be a method of supplying a source gas containing oxygen O₂ into a spatial gap in which dielectric barrier discharge is generated and generating a gas containing ozone O₃ by the discharge. More specifically, a pair of metal electrodes arranged in a parallel plate configuration and a pair of dielectrics installed between the metal electrodes are provided, and a source gas containing oxygen O₂ (such as high-concentration oxygen or dehumidified air) from a source gas supply such as an oxygen cylinder or an air tank is fed by a diaphragm pump into the spatial gap between the pair of dielectrics, and a high-frequency high voltage is applied to the pair of metal electrodes by a high-frequency power supply. For the high-frequency power supply, for example, a power supply of 13 MHz and 100 W is used. Note that the method for generating the gas V containing ozone is not limited to the above aspect, and may be an electrolytic method or an ultraviolet lamp method. Alternatively, the gas V containing ozone may be generated as a high-concentration ozone gas by, for example, vaporizing liquid ozone.

The flow path element 12 forms a flow path through which the gas supplied from the gas supply unit 11 flows. The flow path element 12 has an opening 14 formed therein for exposing a part of the flow path to the outside. The predetermined region R is a region exposed to the outside through the opening 14. The gas suction unit 13 is, for example, a pump, and suctions the gas that has flowed through the flow path of the flow path element 12.

The first irradiation unit 20 irradiates the gas V flowing through the predetermined region R of the flow path formed by the flow path element 12 with the first laser light L1 and the second laser light L2. More specifically, the first irradiation unit 20 includes an excitation light source 21 and an interference optical system 30. The interference optical system 30 includes a beam splitter 22 and reflecting mirrors 23A to 23F. The excitation light source 21 outputs laser light L for exciting the gas V. When the gas V containing molecules that resonantly absorb the laser light L is a gas containing ozone, the laser light L (i.e., the first laser light L1 and the second laser light L2) can have a center wavelength particularly strong at the absorption wavelength of ozone (for example, having a wavelength of 230 nm to 280 nm). The pulse width of the laser light L (i.e., the first laser light L1 and the second laser light L2) is in the nanosecond range (for example, 1 ns or more and 100 ns or less), or in the picosecond-to-nanosecond range (for example, 1 ps or more and 100 ns or less).

The beam splitter 22 receives the laser light L output from the excitation light source 21, and splits and outputs the laser light L into the first laser light L1 and the second laser light L2.

The reflecting mirrors 23C, 23D, 23E, and 23F are arranged in order on the optical path of the first laser light L1 output from the beam splitter 22. The reflecting mirrors 23C, 23D, 23E, and 23F sequentially reflect the first laser light L1, thereby causing the first laser light L1 to enter the predetermined region R.

The reflecting mirrors 23A, 23B, and 23F are arranged in order on the optical path of the second laser light L2 output from the beam splitter 22. The reflecting mirrors 23A, 23B, and 23F sequentially reflect the second laser light L2, thereby causing the second laser light L2 to enter the predetermined region R. The reflecting mirrors 23A to 23F guide the first laser light L1 and the second laser light L2 so that the first laser light L1 and the second laser light L2 cross each other in the predetermined region R, and irradiate the predetermined region R with the first laser light L1 and the second laser light L2.

As a result, in the predetermined region R, a spatially periodic intensity distribution (interference fringe) is obtained by the interference of the first laser light L1 and the second laser light L2. The fringe interval of these interference fringes is, for example, several μm, but may be variable. Note that the reflecting mirrors 23A to 23F may be arranged so that the optical path lengths of the first laser light L1 and the second laser light L2 from the beam splitter 22 to the predetermined region R substantially coincide with each other. Also, the first laser light L1 and the second laser light L2 may be caused to enter the predetermined region R so as to have the same intensity. Note that in order to increase the visibility of the interference fringes, it is desirable that the intensities of the first laser light L1 and the second laser light L2 be equal, but the interference fringes can be formed even if they are not equal.

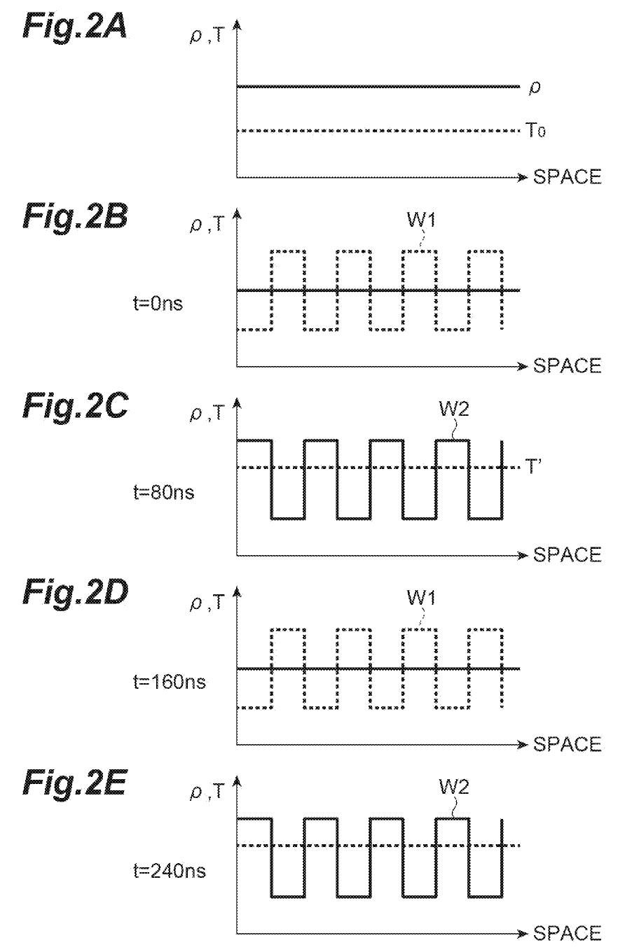

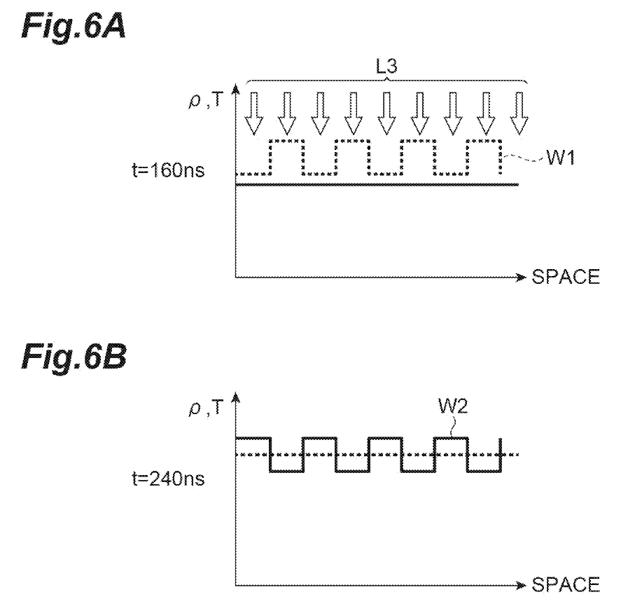

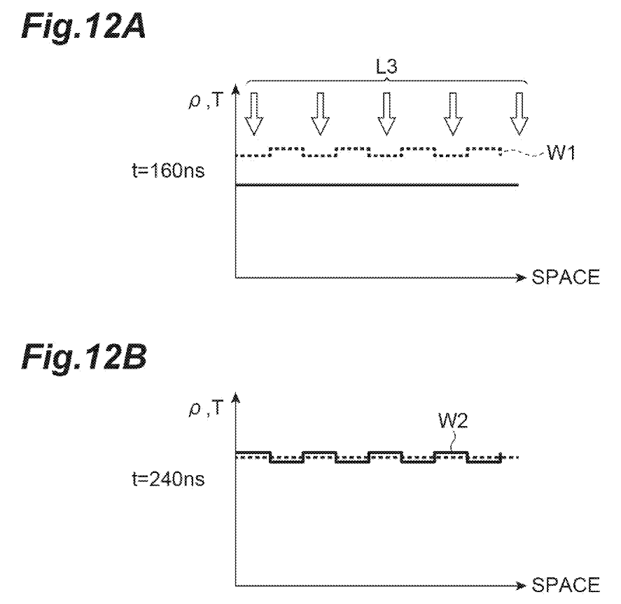

As a result of the interference fringes being formed in the predetermined region R by the interference of the first laser light L1 and the second laser light L2, a density modulation wave is formed in the gas V in the predetermined region R. As illustrated in FIG. 2A, it is assumed that the temperature T and density ρ of the gas V in the predetermined region R are spatially uniform before the first laser light L1 and the second laser light L2 are irradiated. Note that in each of the graphs of FIGS. 2A, 2B, 2C, 2D, and 2E (and FIGS. 6A, 6B, 12A, and 12B described later), the dashed line indicates the temperature T of the gas V, and the solid line indicates the density ρ.

In that state, as illustrated in FIG. 2B (time t = 0 ns), when the first laser light L1 and the second laser light L2 are irradiated onto the gas V in the predetermined region R and interference fringes are formed in the predetermined region R, light absorption of the first laser light L1 and the second laser light L2 occurs in the gas V in accordance with the interference fringes, whereby a high-low wave W1 of temperature T (a state in which portions of high temperature T and portions of low temperature T of the gas V are alternately formed in a stripe pattern) is spatially formed in the gas V.

Thereafter, as illustrated in FIG. 2C (for example, time t = 80 ns), with the time evolution, the high-temperature portions of the gas V expand and the low-temperature portions of the gas V are compressed, and as a result, a density modulation wave W2 having an opposite phase to the high-low wave W1 of the gas V (a state in which portions of high density ρ and portions of low density ρ of the gas V are alternately formed in a stripe pattern) is spatially formed. Furthermore, as illustrated in FIGS. 2D and 2E (for example, times t = 160 ns and 240 ns), with further time evolution, time-varying spatial modulation of density ρ of the gas V due to the density modulation wave W2 and time-varying spatial modulation of high and low temperatures due to the high-low wave W1 related to temperature T alternately and repeatedly occur.

In this manner, the first irradiation unit 20 forms interference fringes in the predetermined region R by irradiating the predetermined region R with the first laser light L1 and the second laser light L2 so that they cross each other in the predetermined region R, thereby forming the density modulation wave W2 in the gas V in the predetermined region R due to the interference fringes. The repetition time period of the spatial modulation of density due to this density modulation wave W2 depends on the interference fringe interval.

As illustrated in FIG. 1, in a state in which the density modulation wave W2 is formed in the gas V in the predetermined region R, the controlled laser light Lin output from a predetermined optical system So is irradiated onto the predetermined region R, whereby the controlled laser light Lin is diffracted and diffracted laser light Lo is generated. The laser light Lo may be irradiated onto, for example, a processing target 50 to be used for laser processing of the processing target 50. Note that the optical system So is, for example, a laser light source including an amplifier. A part of the laser light Lo irradiated onto the processing target 50 may become scattered/reflected light Lp. Therefore, it is desirable to prevent a part of the scattered/reflected light Lp from returning to the optical system So or the like as return light. The means for suppressing the return light will be described later.

The second irradiation unit 40 includes a light source 41 and a reflecting mirror 42. The light source 41 outputs the third laser light L3. The reflecting mirror 42 causes the third laser light L3 to enter the predetermined region R by reflecting the third laser light L3 output from the light source 41.

The third laser light L3, like the first laser light L1 and the second laser light L2, has a center wavelength particularly strong at the absorption wavelength of ozone (for example, having a wavelength of 230 nm to 280 nm). Also, the pulse width of the third laser light L3 is in the nanosecond range (for example, 1 ns or more and 100 ns or less), or in the picosecond-to-nanosecond range (for example, 1 ps or more and 100 ns or less). Furthermore, the fluence and pulse energy of the third laser light L3 are, for example, equal to or greater than those of the first laser light L1 and the second laser light L2, and are 10 mJ/cm² or more (for example, 60 mJ/cm²) and 1 mJ or more, respectively.

Also, the third laser light L3 may be irradiated onto the entire irradiation region of the first laser light L1 and the second laser light L2 in the predetermined region R. In other words, the irradiation region of the third laser light L3 may be configured to include the irradiation region of the first laser light L1 and the second laser light L2 in the predetermined region R. As an example, the irradiation region of the third laser light L3 is equal to or greater than the irradiation region of the first laser light L1 and the second laser light L2, and is, for example, 10 mm × 10 mm or more.

The second irradiation unit 40 irradiates the predetermined region R with the third laser light L3 in a peak region of diffraction efficiency of light based on the density modulation wave W2, the peak region being within a time range after the first laser light L1 and the second laser light L2 are irradiated onto the predetermined region R. This point will be described more specifically.

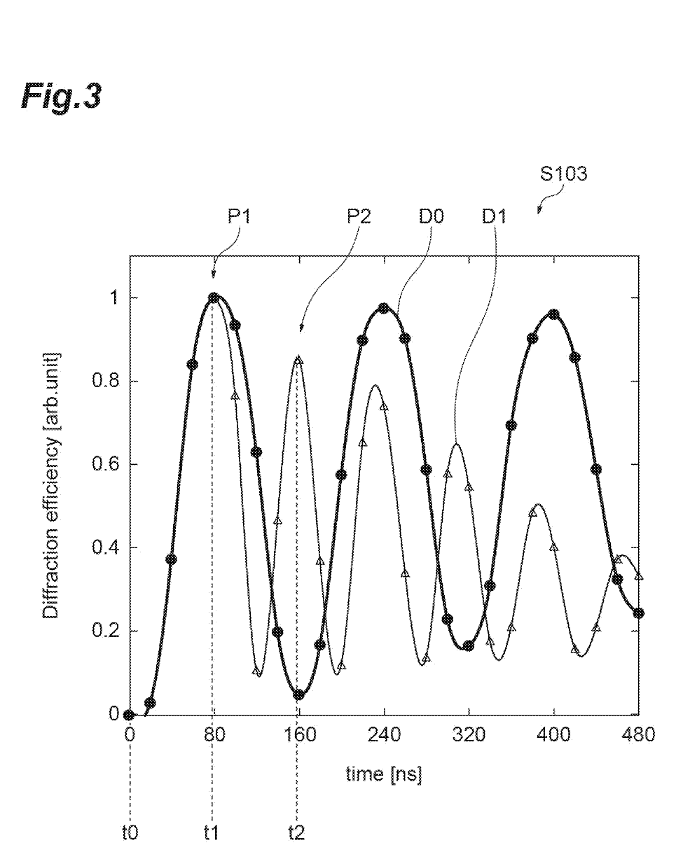

FIG. 3 is a graph illustrating the time change of the diffraction efficiency of light based on the density modulation wave. The diffraction efficiency D0 in FIG. 3 is the diffraction efficiency of light based on the density modulation wave W2 induced by the interference fringes of the first laser light L1 and the second laser light L2 that are irradiated at time t0. The second irradiation unit 40 irradiates the predetermined region R with the third laser light L3 in the peak region of the diffraction efficiency D0. Here, the peak region of the diffraction efficiency D0 is a time range in which the diffraction efficiency D0 is 80% or more relative to the peak P1. As an example, the second irradiation unit 40 irradiates the third laser light L3 at time t1 at which the diffraction efficiency D0 reaches the peak P1 within the peak region. Time t1 is, for example, a time 80 ns after time t0.

As a result, after time t1, a different diffraction efficiency D1 is obtained. The diffraction efficiency D1 is the diffraction efficiency obtained by irradiating the predetermined region R with the third laser light L3 in the peak region of the diffraction efficiency D0 of light based on the density modulation wave W2. The diffraction efficiency D0 and the diffraction efficiency D1 have temporal periodicity due to the temporal periodicity of the density modulation wave W2. The period of the diffraction efficiency D1 is shorter than the period of the diffraction efficiency D0 (more specifically, the period is halved). This means that the spatial frequency of the density modulation wave W2 increases (the interval of the diffraction grating formed in the gas V decreases). In the illustrated example, the period of the diffraction efficiency D1 (approximately 80 ns as an example) is approximately half of the period of the diffraction efficiency D0 (approximately 160 ns as an example), and the spatial frequency of the density modulation wave W2 is approximately doubled.

In this manner, the second irradiation unit 40 increases the spatial frequency of the density modulation wave W2 compared to before the irradiation of the third laser light L3, by irradiating the predetermined region R with the third laser light L3 in the peak region of diffraction efficiency of light based on the density modulation wave W2, the peak region being within a time range after the first laser light L1 and the second laser light L2 are irradiated onto the predetermined region R.

Furthermore, the second irradiation unit 40 may further irradiate the predetermined region R with the third laser light L3 in the peak region of the diffraction efficiency D1 of light based on the density modulation wave W2 whose spatial frequency has been increased by the irradiation of the third laser light L3, thereby further increasing the spatial frequency of the density modulation wave W2. For example, the second irradiation unit 40 can irradiate the third laser light L3 at time t2 at which the diffraction efficiency D1 reaches the peak P2 within the peak region of the diffraction efficiency D1. The period of the diffraction efficiency in this case is further approximately half of the period of the diffraction efficiency D1, and the spatial frequency of the density modulation wave W2 is approximately doubled again (approximately four times the initial value).

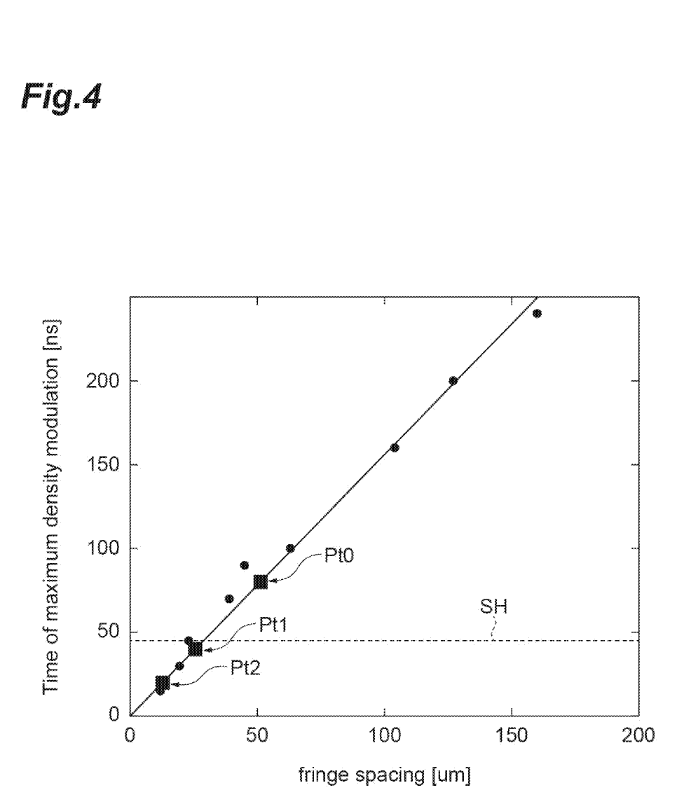

FIG. 4 is a graph illustrating the relationship between the rise time of the diffraction efficiency (vertical axis) and the interval of the density modulation wave (horizontal axis). As illustrated in FIG. 4, the rise time to the peak of the diffraction efficiency of light based on the density modulation wave W2 and the spatial interval of the density modulation wave W2 have a linear relationship. Point Pt0 in FIG. 4 is a point corresponding to the diffraction efficiency D0, and point Pt1 is a point corresponding to the diffraction efficiency D1. Point Pt2 is a point corresponding to the diffraction efficiency when the third laser light L3 is further irradiated in the peak region of the diffraction efficiency D1.

When the irradiation of the third laser light L3 is not performed, the points in the region above the line SH illustrated in the FIGURE(the side with a longer rise time) correspond to cases where the pulse widths of the first laser light L1 and the second laser light L2 are varied in the nanosecond range, and the points in the region below the line SH (the side with a shorter rise time) are cases where the pulse widths of the first laser light L1 and the second laser light L2 are varied in the picosecond range. Therefore, in order to further shorten the rise time of the diffraction efficiency, it is conceivable to shorten the pulse widths of the first laser light L1 and the second laser light L2 to the picosecond range, but by the second irradiation unit 40 irradiating the third laser light L3 as described above, it becomes possible to achieve rise times in the region below the line SH even when the pulse widths of the first laser light L1 and the second laser light L2 (and furthermore the third laser light L3) are in the nanosecond range.

Note that in the example of FIG. 3, the second irradiation unit 40 irradiates the third laser light L3 at time t1 at which the diffraction efficiency D0 first reaches the peak P1 after the first laser light L1 and the second laser light L2 are irradiated at time t0. Also, the second irradiation unit 40 irradiates the third laser light L3 at time t2 at which the diffraction efficiency D1 first reaches the peak P2 after the third laser light L3 is irradiated at time t1.

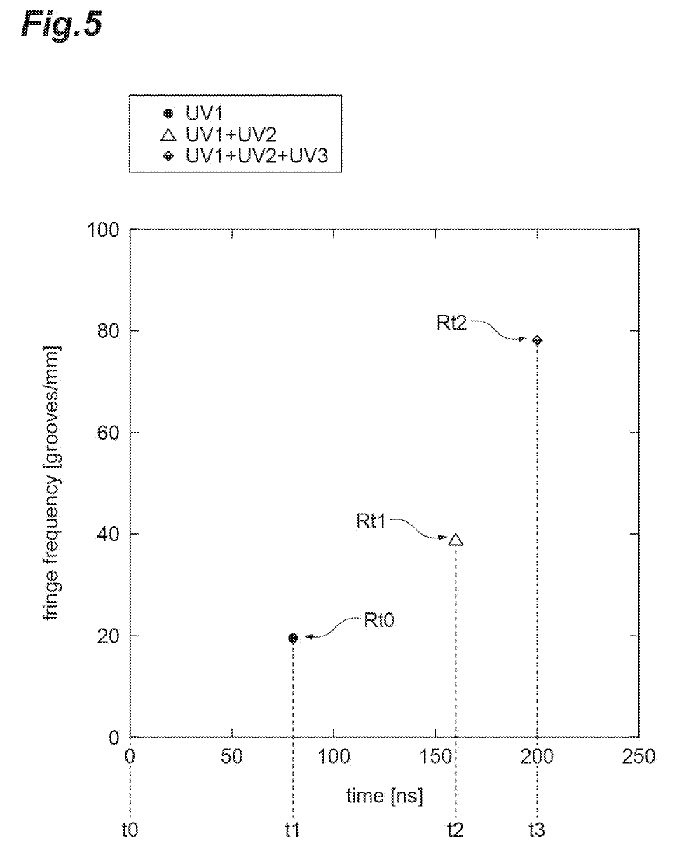

As a result, as illustrated in FIG. 5, the interval of the density modulation wave W2 (number of grooves/mm) narrows from 19 grooves/mm at time t1 (approximately 80 ns) to 38 grooves/mm, which is twice as many, at time t2 (approximately 160 ns), and is further narrowed to 76 grooves/mm, which is twice as many again, at time t3 (approximately 200 ns). In this manner, according to the diffraction device 100, it is possible to easily increase the spatial frequency of the density modulation wave W2 of the gas V without reducing the pulse widths of the first laser light L1 and the second laser light L2. Note that in the graph of FIG. 3, the amplitude of the diffraction efficiency D1 decreases over time. This is because the graph of FIG. 3 is a measurement example in which the incident angle of the controlled laser light Lin is fixed to match the spatial frequency of the initial density modulation wave W2 (diffraction efficiency D0), and therefore the diffraction efficiency decreases for the density modulation wave W2 (diffraction efficiency D1) with twice the spatial frequency. Therefore, it is possible to optimize the diffraction efficiency (suppressing unintended decrease in the amplitude of the diffraction efficiency) by changing the incident angle of the controlled laser light Lin for the density modulation wave W2 of each spatial frequency.

Here, in addition to the function of increasing the spatial frequency of the density modulation wave W2 as described above, the second irradiation unit 40 may have a function of intentionally reducing the amplitude of the density modulation wave W2. This point will be described subsequently.

The second irradiation unit 40 can reduce the amplitude of the density modulation wave W2 described above by irradiating the predetermined region R with the third laser light L3 after the first laser light L1 and the second laser light L2 are irradiated onto the predetermined region R. That is, as illustrated in FIG. 6A (for example, time t = 160 ns), when the second irradiation unit 40 irradiates the gas V in the predetermined region R with the third laser light L3 and light absorption of the third laser light L3 occurs in the gas V, the low-temperature portions of the gas V are heated more efficiently than the high-temperature portions, and as a result, the amplitude of the high-low wave W1 (the temperature difference between high and low) is reduced. As a result, as illustrated in FIG. 6B (for example, time t = 240 ns), the amplitude of the density modulation wave W2 of the gas V (the density difference between high and low) formed in accordance with the high-low wave W1 with the time evolution is also reduced. Note that in the illustrated example, the second irradiation unit 40 uniformly irradiates the third laser light L3 onto both the high-temperature portions and the low-temperature portions of the gas V.

In this manner, in the diffraction device 100, it is possible to switch between a state in which the density modulation wave W2 is formed in the gas V in the predetermined region R by irradiating the predetermined region R with the first laser light L1 and the second laser light L2 and the controlled laser light Lin can be diffracted, and a state in which the amplitude of the density modulation wave W2 is reduced and the controlled laser light Lin is less likely to be diffracted (not diffracted) by irradiating the predetermined region R with the third laser light L3 after the first laser light L1 and the second laser light L2 are irradiated.

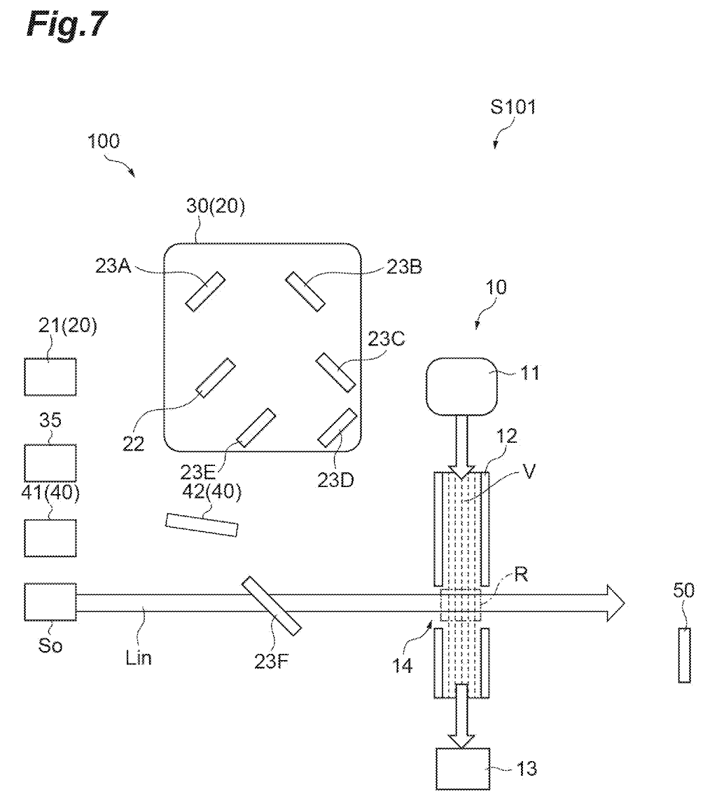

That is, as illustrated in FIG. 7, in the initial state before the first laser light L1, the second laser light L2, and the third laser light L3 are irradiated onto the predetermined region R, since the density modulation wave W2 is not formed in the gas V in the predetermined region R, the controlled laser light Lin is not diffracted in the predetermined region R. For this reason, the controlled laser light Lin emitted from the predetermined region R does not enter the processing target 50.

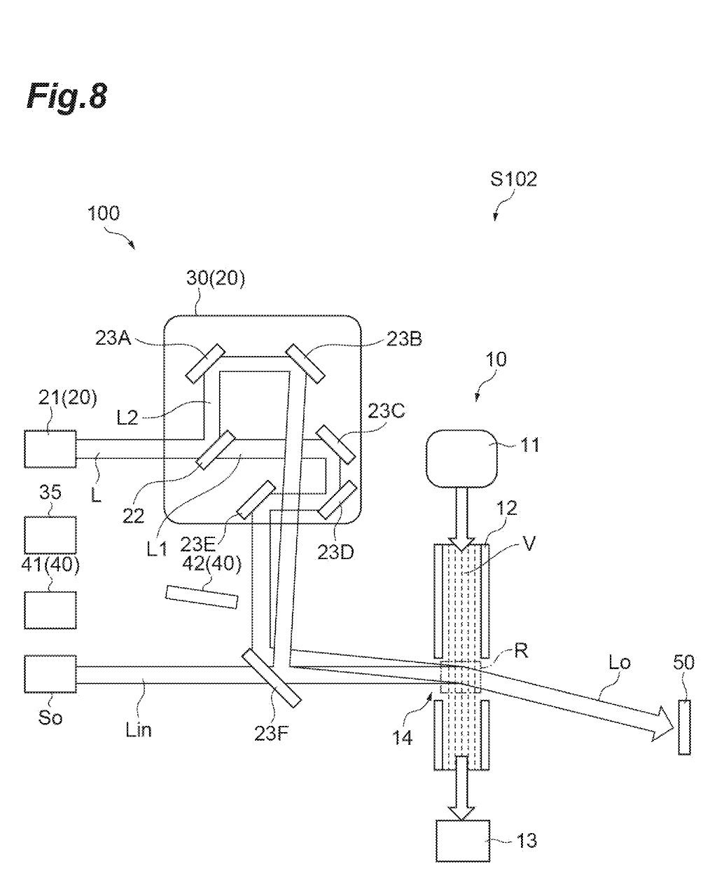

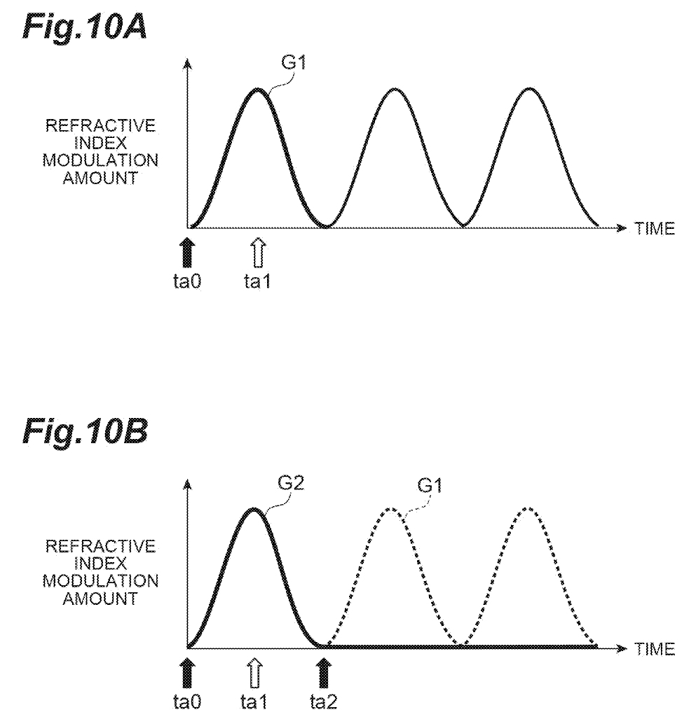

Thereafter, as illustrated in FIG. 8, the first irradiation unit 20 irradiates the predetermined region R with the first laser light L1 and the second laser light L2, whereby the density modulation wave W2 is formed in the gas V in the predetermined region R. At this time, the second irradiation unit 40 is not irradiating the third laser light L3 (however, in the present embodiment, the irradiation of the third laser light L3 has been performed in advance for the purpose of increasing the spatial frequency of the density modulation wave W2). In this case, as illustrated in FIG. 10A, a refractive index modulation amount G1 corresponding to the density modulation wave W2 is generated in the predetermined region R. Here, the time ta1 at which the controlled laser light Lin is irradiated is the time at which the density modulation structure of the density modulation wave W2 is at a maximum, and is the time at which the diffraction efficiency is at a maximum. As a result, the controlled laser light Lin is diffracted in the predetermined region R, whereby the laser light Lo, which is diffracted light, is generated and irradiated onto the processing target 50.

Note that the time at which the first laser light L1 and the second laser light L2 are irradiated is defined as time ta0, and the time ta1 at which the controlled laser light Lin is irradiated may be set to a time of a first peak of the refractive index modulation amount G1 after time ta0. In contrast, in the present embodiment, the time ta1 corresponds to a peak occurring after the third laser light L3 has been irradiated at least once for the purpose of increasing the spatial frequency of the density modulation wave W2.

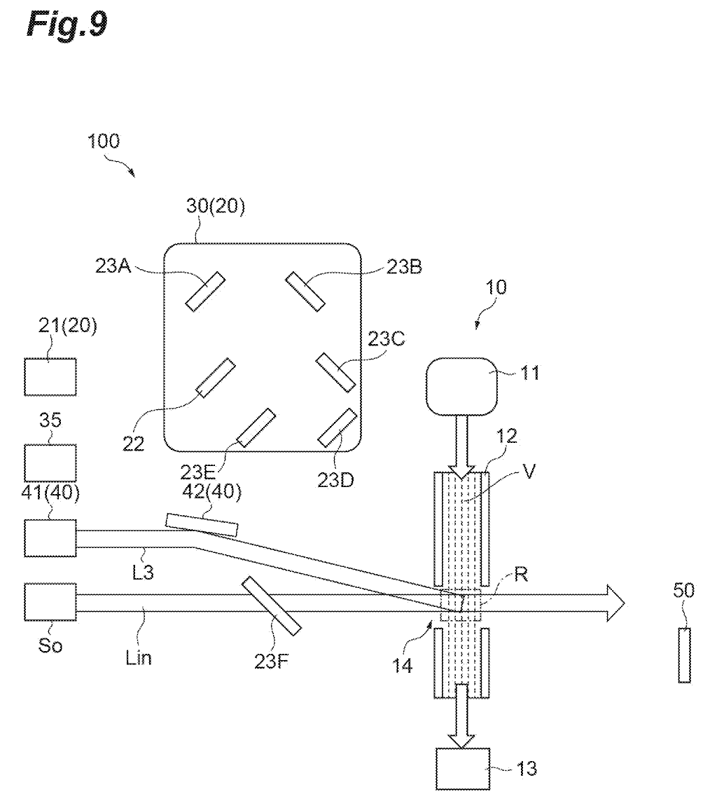

Thereafter, as illustrated in FIG. 9, the second irradiation unit 40 irradiates the predetermined region R with the third laser light L3, whereby the amplitude of the density modulation wave W2 of the gas V is reduced. At this time, the first irradiation unit 20 is not irradiating the first laser light L1 and the second laser light L2. In this case, as illustrated in FIG. 10B, after time ta2 at which the third laser light L3 is irradiated, the peak of the refractive index modulation amount G1 is reduced (for example, the peak disappears) in accordance with the reduction of the amplitude of the density modulation wave W2, resulting in a different refractive index modulation amount G2. Therefore, after time ta2, the controlled laser light Lin is not diffracted in the predetermined region R and does not enter the processing target 50. In the diffraction device 100, the control of the diffraction state may be performed as described above.

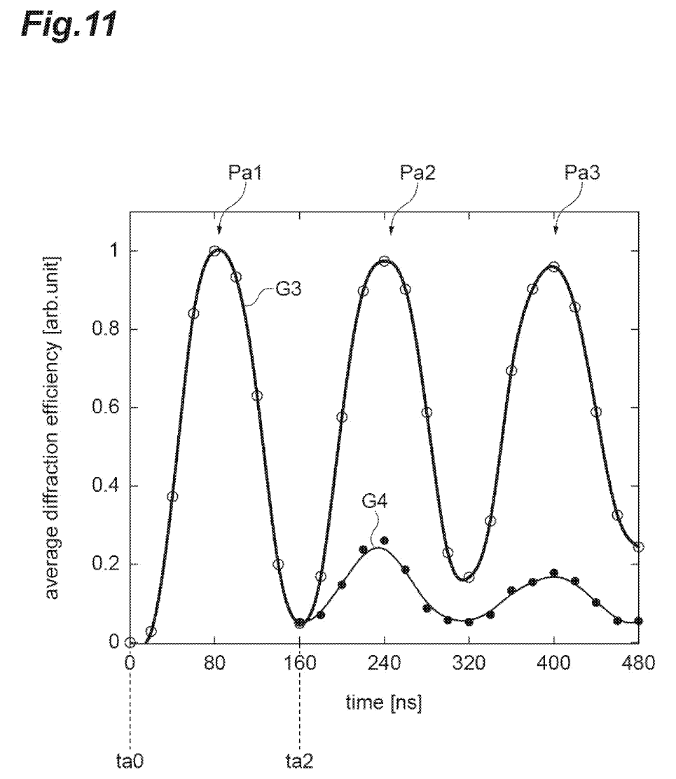

FIG. 11 is a graph illustrating the relationship between the diffraction efficiency of light based on the density modulation wave and time. As illustrated in FIG. 11, the second irradiation unit 40 can irradiate the predetermined region R with the third laser light L3 at a time between temporally adjacent peaks of the diffraction efficiency G3 of light based on the density modulation wave W2. In the illustrated example, the second irradiation unit 40 irradiates the predetermined region R with the third laser light L3 at time ta2 between the first two peaks Pa1 and Pa2 of the diffraction efficiency G3 occurring after the time point (time ta0) at which the first laser light L1 and the second laser light L2 are irradiated. However, in the present embodiment, the peaks Pa1 and Pa2 are the first two peaks after the third laser light L3 has been irradiated at least once for the purpose of increasing the spatial frequency of the density modulation wave W2.

In particular, the second irradiation unit 40 can irradiate the predetermined region R with the third laser light L3 in the time range (time ta2) in which the diffraction efficiency G3 is at its minimum. The time range in which the diffraction efficiency G3 is at its minimum is, for example, a time range in which the diffraction efficiency G3 is approximately 20% or less of the peak Pa1. In other words, by irradiating the predetermined region R with the third laser light L3 in the time range in which the diffraction efficiency G3 is approximately 20% or less of the peak Pa1, the amplitude of the density modulation wave W2 can be effectively reduced. As a result, the peaks Pa2 and Pa3 that would have occurred in the diffraction efficiency G3 without the irradiation of the third laser light L3 are reduced, resulting in a different diffraction efficiency G4. Therefore, in this case, it becomes possible to efficiently diffract the controlled laser light Lin only in the vicinity of the first peak Pa1.

Note that, as an example, as illustrated in FIG. 1, the diffraction device 100 may include a control unit 35. The control unit 35 may control the first irradiation unit 20 and the second irradiation unit 40 so as to control the timing of irradiation of the first laser light L1 and the second laser light L2 and the timing of irradiation of the third laser light L3, thereby performing the above-described increase of the spatial frequency of the density modulation wave W2 and/or the control of the diffraction state. The control unit 35 may be configured as, for example, a computer device including a processor, a memory, storage, a communication device, and the like. Further, in the control unit 35, the processor executes software (programs) loaded into the memory or the like, and controls reading and writing of data in the memory and storage, and communication by the communication device, whereby various processes for controlling each unit such as the first irradiation unit 20 and the second irradiation unit 40 can be performed.

Subsequently, the diffraction method according to the present embodiment will be described. In this diffraction method, first, as illustrated in FIGS. 1 and 7, a gas is supplied to the predetermined region R (step S101: supply step). In step S101, neither the first laser light L1 nor the second laser light L2 is irradiated, and the third laser light L3 is not irradiated.

Subsequently, as illustrated in FIGS. 1 and 8, the first laser light L1 and the second laser light L2 are irradiated onto the predetermined region R (step S102: first irradiation step). In step S102, interference fringes are formed in the predetermined region R by irradiating the predetermined region R with the first laser light L1 and the second laser light L2 so as to cross each other in the predetermined region R, thereby forming the density modulation wave W2 in the gas V in the predetermined region R due to the interference fringes. In step S102, the third laser light L3 is not irradiated.

Subsequently, as illustrated in FIGS. 1 and 3, the third laser light L3 is irradiated onto the predetermined region R (step S103: second irradiation step). In step S103, after the first laser light L1 and the second laser light L2 are irradiated onto the predetermined region R, the spatial frequency of the density modulation wave W2 is increased by irradiating the predetermined region R with the third laser light L3 in the peak region of the diffraction efficiencies D0 and D1 of light based on the density modulation wave W2, the peak region being within a time range after the first laser light L1 and the second laser light L2 are irradiated onto the predetermined region R.

As described above, in the diffraction device 100 and the diffraction method according to the present embodiment, the first laser light L1 and the second laser light L2 are irradiated onto the predetermined region R to which the gas V has been supplied so as to cross each other, thereby forming interference fringes in the predetermined region R. The gas V includes molecules that resonantly absorb the first laser light L1 and the second laser light L2 (and the third laser light L3). As a result, a density modulation wave W2 (a state in which portions of high density and portions of low density of the gas are alternately formed in a stripe pattern) caused by the interference fringes is formed in the gas V in the predetermined region R. This makes it possible to diffract the controlled laser light Lin by, for example, causing the controlled laser light Lin to enter the predetermined region R in which the density modulation wave W2 of the gas V has been formed (i.e., a state in which the controlled laser light Lin can be diffracted is achieved).

Then, in the diffraction device 100 and the diffraction method according to the present embodiment, the third laser light L3 is further irradiated onto the predetermined region R in the peak region of the diffraction efficiencies D0 and D1 of light based on the density modulation wave W2, the peak region being within a time range after the first laser light L1 and the second laser light L2 are irradiated onto the predetermined region R. As a result, the spatial frequency of the density modulation wave W2 of the gas V increases. In this manner, according to this diffraction device 100 and diffraction method, it is possible to easily increase the spatial frequency of the density modulation wave W2 of the gas V without reducing the pulse widths of the first laser light L1 and the second laser light L2 or increasing the crossing angle of the first laser light L1 and the second laser light L2.

Also, in the diffraction device 100 according to the present embodiment, the peak region is a time range in which the diffraction efficiencies D0 and D1 of light based on the density modulation wave W2 are 80% or more relative to the peaks P1 and P2. For this reason, the spatial frequency of the density modulation wave W2 of the gas V can be increased more reliably.

Also, in the diffraction device 100 according to the present embodiment, the pulse widths of the first laser light L1 and the second laser light L2 may be 1 ns or more. In this case, the spatial frequency of the density modulation wave W2 of the gas V can be increased without using a laser with a pulse width narrower than a nanosecond, which tends to make the configuration more complex.

Also, in the diffraction device 100 according to the present embodiment, the second irradiation unit 40 may further irradiate the predetermined region R with the third laser light L3 in the peak region of the diffraction efficiency D1 of light based on the density modulation wave W2 whose spatial frequency has been increased by the irradiation of the third laser light L3, thereby further increasing the spatial frequency of the density modulation wave W2. In this case, the spatial frequency of the density modulation wave W2 of the gas V can be further increased.

Also, in the diffraction device 100 according to the present embodiment, the gas V may include ozone, and the first laser light L1, the second laser light L2, and the third laser light L3 may have center wavelengths at the absorption wavelength of ozone. In this manner, by the gas V including ozone and the first laser light L1, the second laser light L2, and the third laser light L3 having center wavelengths at the absorption wavelength of ozone, it is possible to suitably form the density modulation wave W2 in the gas V in the predetermined region R and suitably reduce the amplitude of the density modulation wave W2.

Also, in the diffraction device 100 according to the present embodiment, the fluence of the third laser light L3 may be equal to or greater than the fluence of the first laser light L1 and the second laser light L2. In this case, it becomes possible to more reliably reduce the amplitude of the density modulation wave W2 of the gas V by the irradiation of the third laser light L3.

Also, in the diffraction device 100 according to the present embodiment, the pulse energy of the third laser light L3 may be equal to or greater than the pulse energy of the first laser light L1 and the second laser light L2. In this case, it becomes possible to more reliably reduce the amplitude of the density modulation wave W2 of the gas V.

Furthermore, in the diffraction device 100 according to the present embodiment, the irradiation region of the third laser light L3 in the predetermined region R may include the irradiation region of the first laser light L1 and the second laser light L2 in the predetermined region R. In this case, it becomes possible to reduce the amplitude of the density modulation wave W2 of the gas V over the entire irradiation region of the first laser light L1 and the second laser light L2 by the irradiation of the third laser light L3.

Further, in the diffraction device 100 according to the present embodiment, the second irradiation unit 40 may further irradiate the predetermined region R with the third laser light L3 in a time range in which the diffraction efficiency G3 of light based on the density modulation wave W2 whose spatial frequency has been increased by the irradiation of the third laser light L3 is 20% or less relative to the peak Pa1, thereby reducing the amplitude of the density modulation wave W2. In this case, after the third laser light L3 is irradiated, the amplitude of the density modulation wave W2 of the gas V is reduced, and as a result, the controlled laser light Lin incident on the predetermined region R becomes less likely to be diffracted (i.e., a state in which the controlled laser light Lin is less likely to be diffracted is achieved). That is, in this case, it becomes possible to switch at high speed between a state in which the controlled laser light Lin can be diffracted and a state in which the controlled laser light Lin is less likely to be diffracted (i.e., the diffraction state) in accordance with the irradiation of the third laser light L3.

Here, as described above, the density modulation wave W2 of the gas V formed in the predetermined region R by the irradiation of the first laser light L1 and the second laser light L2 repeatedly generates time-varying spatial modulation of density. That is, the peaks of the diffraction efficiency G3 of light based on the density modulation wave W2 of the gas V repeatedly occur over time. According to the knowledge of the present inventors, by irradiating the predetermined region R with the third laser light L3 at a time between temporally adjacent peaks of the diffraction efficiency G3, it is possible to suitably reduce the amplitude of the density modulation wave W2 that would have occurred after that time.

Therefore, in the diffraction device 100 according to the present embodiment, the second irradiation unit 40 can irradiate the predetermined region R with the third laser light L3 at a time between temporally adjacent peaks of the diffraction efficiency G3 of light based on the density modulation wave W2. In this case, as described above, it is possible to suitably reduce the amplitude of the density modulation wave W2 of the gas V and to more reliably control the diffraction state.

Conventionally, an isolator utilizing the Faraday effect has been used as an element for preventing the backward propagation of laser light in order to suppress return light. In this case, since a solid medium element is used, the damage threshold for laser light is small, and it is necessary to increase the cross-sectional area of the element. Further, in many cases, this element utilizes the rotation of polarization, and therefore can only be used with polarized light. In contrast, in the diffraction device 100 according to the present embodiment, it is possible to suppress return light without controlling the polarization of the controlled laser light Lin (i.e., without depending on the polarization state of the controlled laser light Lin). That is, the diffraction device 100 can be operated with any polarization state of the controlled laser light Lin. Further, the diffraction device 100 can also be used for decoupling of ASE light between laser light amplification stages.

Further, in the diffraction device 100 according to the present embodiment, the second irradiation unit 40 can irradiate the predetermined region R with the third laser light L3 in the time range in which the diffraction efficiency G3 is at its minimum. In this case, it is possible to more reliably reduce the amplitude of the density modulation wave W2 of the gas V.

The above embodiment describes one aspect of the present invention. Therefore, the present invention is not limited to the above embodiment and may be variously modified.

For example, in the above embodiment, an example has been described in which the second irradiation unit 40 uniformly irradiates the third laser light L3 onto both the high-temperature portions and the low-temperature portions of the gas V (see FIG. 6A). However, as illustrated in FIG. 12A, the second irradiation unit 40 may selectively irradiate the third laser light L3 onto portions of the gas V where the temperature is relatively low. In this case, the portions of the gas V where the temperature is relatively low are effectively heated, and the amplitude of the high-low wave W1 of the temperature T of the gas V is more reliably reduced. As a result, as illustrated in FIG. 12B, the amplitude of the density modulation wave W2 of the gas V is more reliably reduced.

Further, in the above embodiment, the light source for the first laser light L1 and the second laser light L2 (excitation light source 21) and the light source for the third laser light L3 (light source 41) are configured separately, but the diffraction device 100 may be configured so that the first laser light L1, the second laser light L2, and the third laser light L3 are output from a single light source.

### DESCRIPTION OF REFERENCE NUMERALS

10: supply unit, 20: first irradiation unit, 40: second irradiation unit, L1: first laser light, L2: second laser light, L3: third laser light, R: predetermined region, V: gas, W2: density modulation wave.

What is claimed is:

1. A diffraction device comprising:
a supply unit configured to supply a gas to a predetermined region;
a first irradiation unit configured to irradiate the predetermined region with first laser light and second laser light; and
a second irradiation unit configured to irradiate the predetermined region with third laser light,
wherein the gas includes molecules that resonantly absorb the first laser light, the second laser light, and the third laser light,
wherein the first irradiation unit forms interference fringes in the predetermined region by irradiating the predetermined region with the first laser light and the second laser light so as to cross each other in the predetermined region, thereby forming a density modulation wave in the predetermined region caused by the interference fringes, and
wherein the second irradiation unit increases a spatial frequency of the density modulation wave by irradiating the predetermined region with the third laser light in a peak region of diffraction efficiency of light based on the density modulation wave, the peak region being within a time range after the first laser light and the second laser light are irradiated onto the predetermined region.

2. The diffraction device according to claim 1, wherein the peak region is a time range in which the diffraction efficiency of light based on the density modulation wave is 80% or more relative to a peak.

3. The diffraction device according to claim 1, wherein pulse widths of the first laser light and the second laser light are 1 ns or more.

4. The diffraction device according to claim 1, wherein the second irradiation unit further irradiates the predetermined region with the third laser light in a peak region of diffraction efficiency of light based on the density modulation wave whose spatial frequency has been increased by the irradiation of the third laser light, thereby further increasing the spatial frequency of the density modulation wave.

5. The diffraction device according to claim 1,
wherein the gas includes ozone, and
wherein the first laser light, the second laser light, and the third laser light have center wavelengths at an absorption wavelength of ozone.

6. The diffraction device according to claim 1, wherein a fluence of the third laser light is equal to or greater than a fluence of the first laser light and the second laser light.

7. The diffraction device according to claim 1, wherein an irradiation region of the third laser light in the predetermined region includes the irradiation region of the first laser light and the second laser light in the predetermined region.

8. The diffraction device according to claim 1, wherein the second irradiation unit further irradiates the predetermined region with the third laser light in a time range in which the diffraction efficiency of light based on the density modulation wave whose spatial frequency has been increased by the irradiation of the third laser light is 20% or less relative to a peak, thereby reducing an amplitude of the density modulation wave.

9. A diffraction method comprising:
a supply step of supplying a gas to a predetermined region;
a first irradiation step of irradiating the predetermined region with first laser light and second laser light; and
a second irradiation step of irradiating the predetermined region with third laser light,
wherein the gas includes molecules that resonantly absorb the first laser light, the second laser light, and the third laser light,
wherein in the first irradiation step, interference fringes are formed in the predetermined region by irradiating the predetermined region with the first laser light and the second laser light so as to cross each other in the predetermined region, thereby forming a density modulation wave in the gas in the predetermined region caused by the interference fringes, and
wherein in the second irradiation step, a spatial frequency of the density modulation wave is increased by irradiating the predetermined region with the third laser light in a peak region of diffraction efficiency of light based on the density modulation wave, the peak region being within a time range after the first laser light and the second laser light are irradiated onto the predetermined region.
